(19) United States
(12) Patent Application Publication
(10) Pub. No.: US 2026/0153368 A1
(43) Pub. Date: Jun. 4, 2026

(54) WAVEGUIDE PLATE AND ULTRASONIC FLOW METER

(71) Applicant: INDUSTRIAL TECHNOLOGY RESEARCH INSTITUTE, Hsinchu (TW)

(72) Inventors: Ko-Ying TSENG, New Taipei City (TW); Bo-Yin CHU, Zhubei City (TW); Ching-Chung YIN, Hsinchu City (TW); Hung-Ming CHEN, Keelung City (TW)

(73) Assignee: INDUSTRIAL TECHNOLOGY RESEARCH INSTITUTE, Hsinchu (TW)

(21) Appl. No.: 18/964,074

(22) Filed: Nov. 29, 2024

(51) Int. Cl. G01F 1/66; G01F 1/667

(52) U.S. Cl. CPC G01F 1/662; G01F 1/667

(57) ABSTRACT

A waveguide plate for conducting ultrasonic signal between a high temperature pipeline and an ultrasonic transducer. The waveguide plate comprises a plate part and multiple periodic holes. The multiple periodic holes penetrate the plate part in a direction perpendicular to the plate part. The waveguide plate with the multiple periodic holes can achieve enhanced heat insulation and ultrasonic conduction efficiency while decreasing size per se.

### TECHNICAL FIELD

The disclosure relates to a system for a wave guide plate, and to an ultrasonic flow meter with waveguide plate.

### BACKGROUND

Nowadays, the use of clamp-on ultrasonic flow meter can measure the flow rate or velocity of the fluid in the pipeline without damaging the pipeline. However, there are a large amount of high-temperature fluids in the pipelines used in industrial processes. For example, the working temperature in pipelines for oil refining in petrochemical plants or other high-temperature processes is often as high as 350° C. The temperature in the thermal oil or molten salt pipelines of the photothermal power generation system can even be as high as 600° C. The regular ultrasonic probes cannot withstand long-term high temperatures, which those high-temperature fluids with large amount of energy consumption cannot be effectively monitored. Since the terminal temperature of ultrasonic probes generally made of piezoelectric materials needs to be lower than 120° C. to avoid the critical Curie temperature of the piezoelectric material from losing activity and reducing its service life. Thus, in existing techniques, a waveguide plate is mounted between the ultrasonic probe and the high temperature pipeline to conduct ultrasonic waves and isolate the high temperature from the pipe wall of the high temperature pipeline.

However, in order to increase the thermal insulation efficiency, the size of conventional waveguide plate is usually designed to be relatively large with complex installation mechanisms and complex working space requirements, which makes the installation of this type of ultrasonic flow meter casting more times and labors. Therefore, the techniques of decreasing the size of waveguide plate while increasing the effect of heat insulation are needed.

### SUMMARY

The disclosure is directed to techniques of the waveguide plate including multiple periodic holes and the ultrasonic flow meter using the waveguide plate including multiple periodic holes. By techniques of the waveguide plate including multiple periodic holes provided by the present disclosure, the size of the waveguide plate for the ultrasonic flowmeter can be decreased while increasing performances of heat insulation and ultrasonic transmission.

According to one embodiment, a waveguide plate, for conducting ultrasonic signal between a high temperature pipeline and an ultrasonic transducer is provided. The waveguide plate includes a plate part. The waveguide plate also includes multiple periodic holes penetrating the plate part in a direction perpendicular to the plate part.

According to another embodiment, an ultrasonic flow meter for a high temperature pipeline is provided. The ultrasonic flow meter includes a first ultrasonic module. The first ultrasonic module includes a first ultrasonic transducer configured to generate an ultrasonic signal. The first ultrasonic module also includes a first waveguide plate. The first waveguide plate is configured to conduct the ultrasonic signal, generated by the first ultrasonic transducer, to the high temperature pipeline and includes a first plate part and multiple first periodic holes. One end of the first waveguide plate is attached to the high temperature pipeline, and another end of the first waveguide plate is attached to the first ultrasonic transducer. The ultrasonic flow meter also includes a second ultrasonic module. The second ultrasonic module includes a second ultrasonic transducer configured to receive the ultrasonic signal. The second ultrasonic module also includes a second waveguide plate. The second wave guide plate is configured to conduct the ultrasonic signal from the high temperature pipeline to the second ultrasonic transducer and includes a second plate part and multiple second periodic holes. One end of the second waveguide plate is attached to the high temperature pipeline, and another end of the second waveguide plate is attached to the second ultrasonic transducer. The multiple first periodic holes penetrate the first plate part in a direction perpendicular to the first plate part, and the multiple second periodic holes penetrate the second plate part in a direction perpendicular to the second plate part.

### BRIEF DESCRIPTION OF THE DRAWINGS

FIG. 1 shows a diagram illustrating the side view of the ultrasonic flow meter and the high temperature pipeline, according to implementations of the present disclosure.

FIGS. 2A and 2B show diagrams illustrating the waveguide plate including multiple periodic holes, according to implementations of the present disclosure.

FIGS. 3A and 3B show diagrams illustrating test results of thermal insulation and ultrasonic transmission of the waveguide plate including multiple periodic holes, according to implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

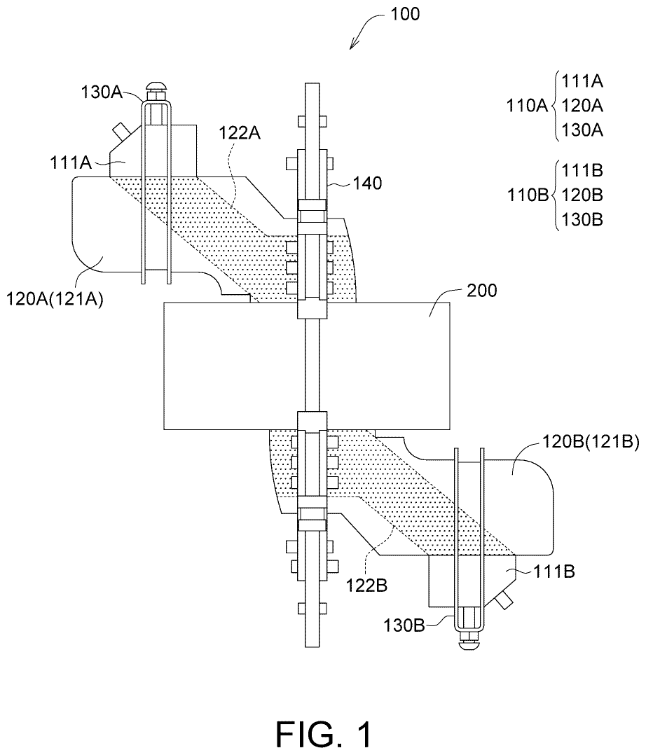

FIG. 1 shows a diagram illustrating the side view of an ultrasonic flow meter 100 and a high temperature pipeline 200, according to implementations of the present disclosure. The ultrasonic flow meter 100 includes a first ultrasonic module 110A, a second ultrasonic module 110B and a pipe clamp 140. The first ultrasonic module 110A includes a first ultrasonic transducer 111A, a first waveguide plate 120A and a first transducer clamp 130A. The second ultrasonic module 110B includes a second ultrasonic transducer 111B, a second waveguide plate 120B and a second transducer clamp 130B. The first ultrasonic transducer 111A can be used for generating ultrasonic signal as an ultrasonic generator, and the second ultrasonic transducer 111B can be used for receiving ultrasonic signal as an ultrasonic receiver. In the case of FIG. 1, the first ultrasonic transducer 111A is used for transmitting ultrasonic signal, and the second ultrasonic transducer 111B is used for receiving ultrasonic signal, as an example, but not limited to. For another example, the first ultrasonic transducer 111A can be used for receiving ultrasonic signal, and the second ultrasonic transducer 111B can be used for generating ultrasonic signal. One end of the first waveguide plate 120A is fixed with the first ultrasonic transducer 111A by the first transducer clamp 130A, and another end of the first waveguide plate 120A directly contacts the high temperature pipeline 200. Similarly, one end of the second waveguide plate 120B is fixed with the second ultrasonic transducer 111B by the second transducer clamp 130B, and another end of the second waveguide plate 120B directly contacts the high temperature pipeline 200. The first waveguide plate 120A and the second waveguide plate 120B are respectively configured to conduct ultrasonic signal between the first ultrasonic transducer 111A or the second ultrasonic transducer 111B, and the high temperature pipeline 200. For example, to cooperate with the first ultrasonic transducer 111A as the ultrasonic generator, the first waveguide plate 120A can be used as a signal transmitting waveguide plate for conducting the ultrasonic signal, generated by the first ultrasonic transducer 111A, to the high temperature pipeline 200. Similarly, to cooperate with the second ultrasonic transducer 111B as the ultrasonic receiver, the second waveguide plate 120B can be used as a signal receiving waveguide plate for conducting the ultrasonic signal from the high temperature pipeline 200 to the second ultrasonic transducer 111B. In some implementations, the structures of the first waveguide plate 120A and the second waveguide plate 120B can be same to each other, and the first waveguide plate 120A and the second waveguide plate 120B also can be replaced with each other. In some implementations, the structure of the first waveguide plate 120A is different from that of the second waveguide plate 120B.

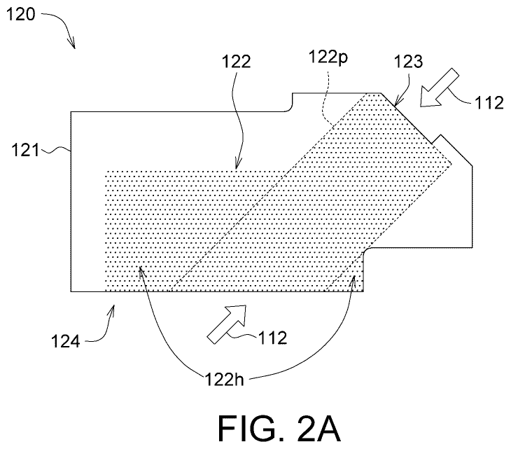

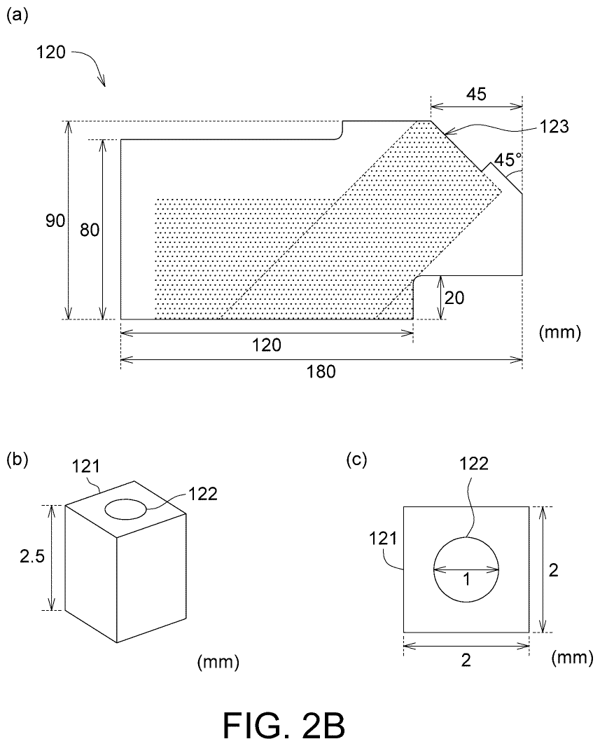

Meanwhile, by the pipe clamp 140, another end, opposite to the first ultrasonic transducer 111A, of the first waveguide plate 120A and another end, opposite to the second ultrasonic transducer 111B, of the second waveguide plate 120B are respectively mounted on two sides of the high temperature pipeline 200, as shown by FIG. 1. The first waveguide plate 120A includes a first plate part 121A and multiple first periodic holes 122A, and the second waveguide plate 120B includes a second plate part 121B and multiple second periodic holes 122B. The multiple first periodic holes 122A and the multiple second periodic holes 122B respectively penetrate the first plate part 121A and the second plate part 1218 in directions perpendicular to the first plate part 121A and the second plate part 121B. The techniques of waveguide plate including multiple periodic holes provided by the implementations according to the present disclosure, can insulate the heat, from contacting the high temperature pipeline, in transmitting direction to the ultrasonic transducer, to decrease the temperature on the end of the waveguide plate contacting the ultrasonic transducer, which the multiple periodic holes also have dispersion characteristics of phononic crystals. Additionally, due to the multiple periodic holes increasing heat dissipation areas of the waveguide plate, the size of the waveguide plate can be reduced accordingly, further simplifying the design of the ultrasonic flow meter 100. The waveguide plate provided by the present disclosure will be detailed described referring to FIGS. 2A and 2B as follows.

FIGS. 2A and 2B show diagrams illustrating a waveguide pate 120 including multiple periodic holes 122, according to implementations of the present disclosure. In the case of FIGS. 2A and 2B, the geometric shape of the waveguide plate 120 is close to rectangular, but not limited to. In some implementations, the geometric shape of the waveguide plate 120 can be circular or other polygonal. As discussed above, the waveguide plate 120 includes a plate part 121 and the multiple periodic holes 122, and the multiple periodic holes 122 penetrate the plate part 121 in the direction perpendicular to the plate part 121, as shown by FIG. 2A. The multiple periodic holes 122 are distributed on a conducting path 122p of the plate part 121 for conducting the ultrasonic signal from the ultrasonic transducer (such as cooperating with the first ultrasonic transducer 111A as the ultrasonic generator of FIG. 1) to the high temperature pipeline 200, or from the high temperature pipeline 200 to the ultrasonic transducer (such as cooperating with the second ultrasonic transducer 111B as the ultrasonic receiver of FIG. 1). Due to a second end 124 of the waveguide plate 120 directly contacting the high temperature pipeline 200, part, excepting the conducting path 122p, of the waveguide plate 120 includes a heat dissipation area 122h, and the multiple periodic holes 122 are also distributed on the heat dissipation area 122h, which facilitates insulating heat from the high temperature pipeline 200. In some implementations, without affecting the strength of the waveguide plate 120, such as not less than the strength that can be fixedly clamped (such as fixedly clamping on a first end 123 and the second end 124 of the waveguide plate 120 of FIG. 2A) by the transducer clamp(such as the first transducer clamp 130A or the second transducer clamp 130B of FIG. 1) or pipe clamp (such as the pipe clamp 140 of FIG. 1), the multiple periodic holes 122 are distributed on the waveguide plate 120 with the largest area possible.

Then referring to FIG. 2B, the schema (a) is an example of the geometric design of the waveguide plate 120. In this example, due to the waveguide plate 120 including the multiple periodic holes 122, which increases thermal insulation and ultrasonic transmission efficiency, the waveguide plate 120 can be reduced to a rectangular design with a size of approximately 180 mm ×90 mm, and its upper left corner and lower right corner are roughly cut off to reduce the cross-sectional area, for heat conduction, of the waveguide plate 120. The upper right of the waveguide plate 120 can be disposed with ultrasonic transducer (such as the first ultrasonic transducer 111A or the second ultrasonic transducer 111B of FIG. 1). Also in this example, the angle between the right side of the waveguide plate 120 and the first end 123 is 45 degrees, thus the direction in which the ultrasonic transducer is fixed at the first end 123 to transmit or receive ultrasonic signals (such as the conducting path 122p of the ultrasonic signal in FIG. 2A, or referred as ultrasonic incident angle) also has an included angle of 45 degrees approximately with the right side of the waveguide plate 120. As shown by schemas (b) and (c) of FIG. 2B, since the multiple periodic holes 122 described in the present disclosure can conform to an acoustic conduction modal and can be a phononic crystal structure, in this case, in the area where the multiple periodic holes 122 are distributed on the plate part 121, there is a circular and 1 mm diameter one of the multiple periodic holes 122, within each 2 mm×2 mm range on the plate part 121, penetrating the plate part 121 with thickness of 2.5 mm, which is the periodic distribution. In some implementations, the multiple periodic holes can be other shapes, such as rectangular shapes or other polygonal shapes, to conform to acoustic conduction modal and can be phononic crystal structures. In some implementations, the plate part 121 can also have one of the multiple periodic holes 122 within each 3 mm×3 mm range, which means that the spacing between the multiple periodic holes 122 can be adjusted according to demands, but not limited to.

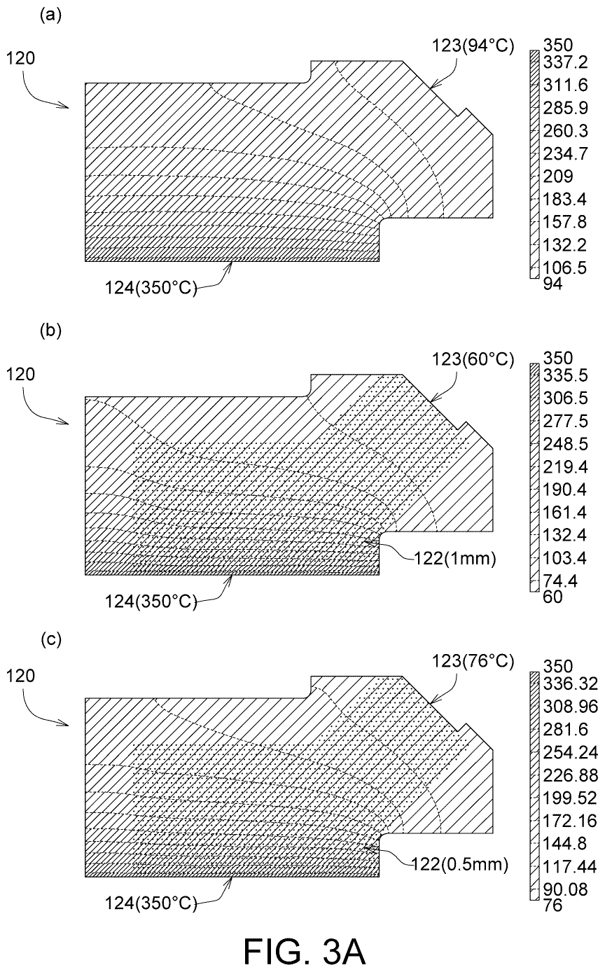

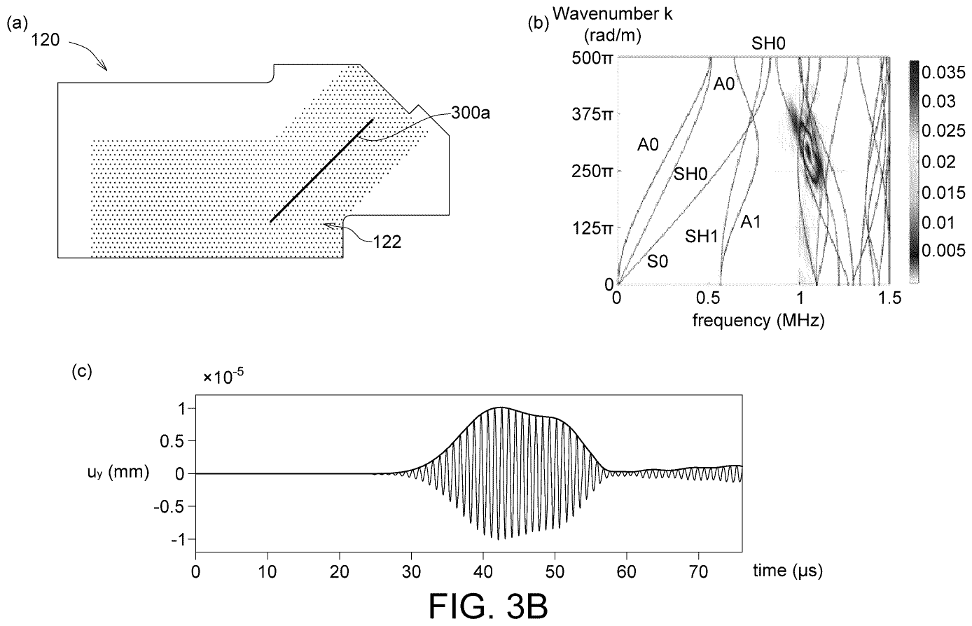

FIGS. 3A and 3B show diagrams illustrating test results of thermal insulation and ultrasonic transmission of the waveguide plate 120 including the multiple periodic holes 122. FIG. 3A shows heat transmitting simulation results of three different types of the waveguide plate 120, and the simulation conditions are which the waveguide plate 120 is made of 304 stainless steel with a thickness of 2 mm, the heat source temperature of the second end 124 (the end contacting the high temperature pipeline 200) is 350° C., the ambient temperature is 40° C., and the heat convection coefficient is h=10 (W/(m²·K)). Regarding the waveguide plate 120 without multiple periodic holes in schema (a), the temperature of the first end 123 (the end contacting the ultrasonic transducer) is 94° C. Regarding the waveguide plate 120 including the multiple periodic holes 122, with 1 mm diameter by each, in schema (b), the temperature of the first end 123 (the end contacting the ultrasonic transducer) is 60° C., Regarding the waveguide plate 120 including the multiple periodic holes 122, with 0.5 mm diameter by each, in schema (c), the temperature of the first end 123 (the end contacting the ultrasonic transducer) is 76° C. Accordingly, the temperature of the first end 123 of the waveguide plate 120 can be reduced from 94° C. to 76° C.˜60° C. through periodic holes of different diameters, thus the waveguide plate including multiple periodic holes provided by implementations of the present disclosure is with the thermal insulation effect.

FIG. 3B shows the test result of ultrasonic transmitting of the waveguide plate 120 including the multiple periodic holes 122 of schema (a) of FIG. 3B, which, in addition to the aforementioned waveguide plate 120 using the multiple periodic holes 122 to form a phononic crystal waveguide structure to increase the heat insulation effect, the waveguide plate 120 including the multiple periodic holes 122 still retains specific modal wave propagation characteristics can still be retained (according to the sampling position 300a). In this case, for the test, the waveguide plate 120 is with thickness of 2 mm, and the diameter of each of the multiple periodic holes 122 is 1 mm. Through the test results generated by transient wave propagation analysis, as shown in the spectrum analysis results of schema (b) in FIG. 3B, it can be known that the wave number has the highest value in the SHO (first plate wave) state, and, as shown by the time domain signal intensity analysis of the phononic crystal waveguide of schema (c) in FIG. 3B, the maximum amplitude is close to 1 mm. Therefore, it can be seen from the above results that the phononic crystal structure formed by multiple periodic holes can be suitable for the design of the waveguide plate of the ultrasonic flow meter.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A waveguide plate, for conducting an ultrasonic signal between a high temperature pipeline and an ultrasonic transducer, comprising:
a plate part; and
a plurality of periodic holes, penetrating the plate part in a direction perpendicular to the plate part.

2. The waveguide plate of claim 1, wherein the plate part has a conducting path, for ultrasonic signal passing from the ultrasonic transducer to the high temperature pipeline, and the plurality of periodic holes are distributed on the conducting path.

3. The waveguide plate of claim 2, wherein the waveguide plate directly contacts the high temperature pipeline, and comprises a heat dissipation area, which the heat dissipation area is disposed on part, excepting the conducting path, of the waveguide plate,
wherein the plurality of periodic holes are distributed on the heat dissipation area.

4. The waveguide plate of claim 1, wherein a shape of the waveguide plate is circular, rectangular or polygonal.

5. The waveguide plate of claim 1, wherein the plurality of periodic holes conform to an acoustic conduction modal, and are phononic crystal structures, and a shape of each of the plurality of periodic holes is circular, rectangular or polygonal.

6. An ultrasonic flow meter, for a high temperature pipeline, comprising:
a first ultrasonic module, comprising:
a first ultrasonic transducer, configured to generate an ultrasonic signal; and
a first waveguide plate, configured to conduct the ultrasonic signal, generated by the first ultrasonic transducer, to the high temperature pipeline and including a first plate part and a plurality of first periodic holes, wherein one end of the first waveguide plate is attached to the high temperature pipeline, and another end of the first waveguide plate is attached to the first ultrasonic transducer; and
a second ultrasonic module, comprising:
a second ultrasonic transducer, configured to receive the ultrasonic signal; and
a second waveguide plate, configured to conduct the ultrasonic signal from the high temperature pipeline to the second ultrasonic transducer and including a second plate part and a plurality of second periodic holes, wherein one end of the second waveguide plate is attached to the high temperature pipeline, and another end of the second waveguide plate is attached to the second ultrasonic transducer,
wherein the plurality of first periodic holes penetrate the first plate part in a direction perpendicular to the first plate part, and the plurality of second periodic holes penetrate the second plate part in a direction perpendicular to the second plate part.

7. The ultrasonic flow meter of claim 6, wherein the first plate part has a first conducting path for conducting the ultrasonic signal, and the second plate part has a second conducting path for conducting the ultrasonic signal,
wherein the plurality of first periodic holes are distributed on the first conducting path, and the plurality of second periodic holes are distributed on the second conducting path.

8. The ultrasonic flow meter of claim 7, wherein the first conducting path is extending from the first ultrasonic transducer to the high temperature pipeline, and the second conducting path is extending from the high temperature pipeline to the second ultrasonic transducer.

9. The ultrasonic flow meter of claim 8, wherein both of the first waveguide plate and the second waveguide plate directly contact the high temperature pipeline,
wherein the first waveguide plate comprises a first heat dissipation area, and the first heat dissipation area is disposed on part, excepting the first conducting path, of the first waveguide plate,
wherein the second waveguide plate comprises a second heat dissipation area, and the second heat dissipation area is disposed on part, excepting the second conducting path, of the second waveguide plate,
wherein the plurality of first periodic hole are distributed on the first heat dissipation area, and the plurality of second periodic hole are distributed on the second heat dissipation area.

10. The ultrasonic flow meter of claim 6, wherein a shape of the first waveguide plate is circular, rectangular or polygonal, and a shape of the second waveguide plate is circular, rectangular or polygonal.

11. The ultrasonic flow meter of claim 6, wherein the plurality of first periodic holes conform to an acoustic conduction modal, and are phononic crystal structures, and a shape of each of the plurality of first periodic holes is circular, rectangular or polygonal,
wherein the plurality of second periodic holes conform to the acoustic conduction modal, and are phononic crystal structures, and a shape of each of the plurality of second periodic holes is circular, rectangular or polygonal.

12. The ultrasonic flow meter of claim 6, further comprising a pipe clamp,
wherein the first ultrasonic module further comprises a first transducer clamp, which the one end of the first waveguide plate is mounted on a side of the high temperature pipeline by the pipe clamp, and the first ultrasonic transducer is mounted on the other end of the first waveguide plate by the first transducer clamp,
wherein the second ultrasonic module further comprises a second transducer clamp, which the one end of the second waveguide plate is mounted on another side of the high temperature pipeline by the pipe clamp, and the second ultrasonic transducer is mounted on the other end of the second waveguide plate by the second transducer clamp.
